(19) United States
(12) Patent Application Publication
(10) Pub. No.: US 2006/0045101 A1
(43) Pub. Date: Mar. 2, 2006

(54) Efficient fault-tolerant messaging for group communication systems

(75) Inventor: Christian Cachin, Thalwil (CH)

Correspondence Address: William A. Kinnaman, Jr.;IBM Corporation - P386, 2455 South Road, Poughkeepsie, NY, 12601, US

(73) Assignee: International Business Machines Corporation, Armonk, NY (US)

(21) Appl. No.: 11/215,752

(22) Filed: Aug. 30, 2005

(30) Foreign Application Priority Data
Aug. 31, 2004 (EP) 04020589.0

(51) Int. Cl. H04L 12/56; H04L 12/28

(52) U.S. Cl. 370/400

(57) ABSTRACT

A system for providing a state value and deriving a final aggregated state value s by a coordinating node. The system includes n nodes in a network having less than k faulty nodes, wherein the flow of state messages forms a tree-like structure among all sets formable by d*k intermediary nodes, with d>1 and k>1, and the coordinating node, the tree-like structure being rooted at the coordinating node. The system provides efficient fault-tolerant messaging for group communication systems.

### CROSS-REFERENCE TO RELATED APPLICATION

This application claims the priority benefit under 35 U.S.C. § 119 of European patent application 04020589.0, filed Aug. 31, 2004, and incorporated herein by reference.

### TECHNICAL FIELD

The present invention is related to a method for providing a state value to n nodes in a network and to a method for deriving a final aggregated state value from state value information provided by n nodes in a network. The invention further relates to corresponding systems, a coordinating node, and an intermediary node. An efficient fault-tolerant messaging for group communication systems is provided.

### BACKGROUND OF THE INVENTION

Group communication systems like ISIS, the ‘Ensemble’ project of Cornell University, and Reliable Scalable Cluster Technology (RSCT) provide protocols to maintain a common state among a set of participating network nodes despite node or link failures (ISIS is a trademark of Stratus Computer, Inc.). RSCT technology was originally developed by International Business Machines Corporation (IBM) for RS/6000 SP systems.

Information related to RSCT can be found in “Group services: Infrastructure for highly available, clustered computing”, P. Badovinatz et al., May 14, 1997, accessed and retrieved from the Internet URL www.research.ibm.com/dss/html/publications_ext.html on Jul. 27, 2004, or in “Processor group membership protocols: Specification, design, implementation”, F. Jahanian, Proceedings 12^{th} Symposium on Reliable Distributed Systems (SRDS'93), pp. 2-11, 1993. Other documents show different structures of group communication systems, such as “Group Communications: A comprehensive study”, G. V. Chockler et al., ACM Computing Surveys, vol. 33, no. 4, pp. 427-469, 2001, “Fat-trees: Universal networks for hardware-efficient supercomputing”, C. E. Leiserson, IEEE Transactions on Computers, vol. 34, pp 892-901, October 1985, or “Group Communication”, D. Powell, Communications of the ACM, vol. 39, pp. 50-97, April 1996.

Further prior art related to group communication systems can be found in U.S. Pat. No. 4,569,015, U.S. Pat. No. 5,704,032, U.S. Pat. No. 5,764,875, U.S. Pat. No. 5,768,538, U.S. Pat. No. 5,787,249, U.S. Pat. No. 5,787,250, U.S. Pat. No. 5,790,772, U.S. Pat. No. 5,790,788, U.S. Pat. No. 5,793,962, U.S. Pat. No. 5,799,146, U.S. Pat. No. 5,805,786, U.S. Pat. No. 5,805,786, U.S. Pat. No. 5,896,503, U.S. Pat. No. 5,926,619, U.S. Pat. No. 6,016,505, and U.S. Pat. No. 6,052,712.

All systems employ protocols in which a designated node—in the following also referred to as coordinating node—sends information to many other nodes, or where a designated node receives information from many other nodes. In a system comprising n nodes, this involves sending n messages over the network and receiving and processing every reply by the coordinating node.

Thus, the computation cost of the coordinating node is proportional to n.

In large systems, the overhead of the coordinating node can become prohibitively large, in particular when the system has hundreds of nodes such as clusters in large computing facilities in operation today. There are systems with thousands of nodes envisaged, where this problem becomes only more acute. From the above it follows that there is still a need in the art for lowering the computation costs.

### SUMMARY OF THE INVENTION

Therefore, in accordance with a first aspect of the present invention, there is provided a method for providing a state value to n nodes in a network. An example method includes the steps of: a coordinating node sending a message comprising at least part of the state value to d*k intermediary nodes forming d sets each set comprising k intermediary nodes, with d>1 and k>1 and k-1 representing a maximum number of faulty intermediary nodes being tolerated in each set. Each intermediary node forwards the message received to d′*k′ further intermediary nodes forming d′ further sets each further set comprising k′ further intermediary nodes, with d′>1 and k′>1 and k′-1 representing a maximum number of faulty further intermediary nodes being tolerated in each further set, or forwards the message received top out of the n nodes. Accordingly, there is also provided a system for providing a state value to n nodes in a network.

In accordance with a second aspect of the present invention, there is provided a method for deriving a final aggregated state value from state value information provided by n nodes in a network. The method includes the steps of: a coordinating node receiving state messages from at least d intermediary nodes belonging to d different sets each set comprising k intermediary nodes, with d>1 and k>1 and k-1 representing a maximum number of faulty intermediary nodes being tolerated in each set, each state message comprising an intermediary aggregated state value, and deriving the final aggregated state value from the intermediary aggregated state values. Accordingly, there is also provided a system for deriving a final aggregated state value from state value information provided by n nodes in a network.

In another embodiment the features of the systems according to the first and the second aspect of the present invention are aggregated.

In accordance with yet another aspect of the invention there are provided computer program elements comprising computer program code for causing steps of any one of the methods described above performed when said elements are run on processor units of network nodes. Additionally, there are provided a coordinating node and an intermediary node, each of which designed for performing the steps assigned to such nodes in the context of the systems as introduced. Advantages of the apparatus, the computer program elements, the coordinating node and the intermediary node, and their embodiments go along with the advantages and embodiments of the methods and the systems as described above.

### BRIEF DESCRIPTION OF THE DRAWINGS

Advantageous embodiments of the invention are described in detail below, by way of example only, with reference to the following schematic drawings, in which:

FIG. 1 shows a schematic illustration of a direct communication between a coordinating node and nodes according to the prior art,

FIG. 2 shows a schematic illustration of a communication between a coordinating node and nodes using a static non-fault-tolerant tree, according to the prior art, and

FIG. 3 shows a schematic illustration of a communication between a coordinating node and nodes using a fault-tolerant tree with d=4 and k=2 according to the invention.

The drawings are provided for illustrative purposes only. Different figures may contain identical references representing elements with similar or uniform content.

### DETAILED DESCRIPTION OF THE INVENTION

The following are definitions to aid in the understanding of the description:
d—number of sets
n—number of nodes in a network
k—fault-tolerance parameter, up to k-1 nodes may be faulty
s—final aggregated state value
p—number of final nodes assigned to a set of intermediary nodes
F—d-ary k-regular fault-tolerant tree, linking the coordinating node and the final nodes
G—d-ary ordinary tree, linking the coordinating node and the final nodes
u—internal node of fault-tolerant tree F
v—internal node of ordinary tree G
t—depth of trees
V—number of internal nodes in the ordinary tree (also number of virtual nodes in the
fault-tolerant tree)

The present invention provides methods for providing a state value to n nodes in a network. An example embodiment of a method includes a coordinating node sending a message comprising at least part of the state value to d*k intermediary nodes forming d sets each set comprising k intermediary nodes, with d>1 and k>1 and k-1 representing a maximum number of faulty intermediary nodes being tolerated in each set. Each intermediary node forwards the message received to d′*k′ further intermediary nodes forming d′ further sets each further set comprising k′ further intermediary nodes, with d′>1 and k′>1 and k′-1 representing a maximum number of faulty further intermediary nodes being tolerated in each further set, or forwards the message received to p out of the n nodes.

The present invention also provides a system for providing a state value to n nodes in a network. The system comprises the n nodes and d*k intermediary nodes forming d sets each set comprising k intermediary nodes, with d>1 and k>1 and k-1 representing a maximum number of faulty intermediary nodes being tolerated in each set. Further, there is provided a coordinating node designed for sending a message comprising at least part of the state value to the d*k intermediary nodes. Each of the d*k intermediary nodes is designed for forwarding the message received to d′*k′ further intermediary nodes forming d′ further sets each further set comprising k′ further intermediary nodes, with d′>1 and k′>1 and k′-1 representing a maximum number of faulty further intermediary nodes being tolerated in each further set, or for forwarding the message received to p out of the n nodes.

The present invention further provides a method for deriving a final aggregated state value from state value information provided by n nodes in a network, comprising a coordinating node receiving state messages from at least d intermediary nodes belonging to d different sets each set comprising k intermediary nodes, with d>1 and k>1 and k-1 representing a maximum number of faulty intermediary nodes being tolerated in each set, each state message comprising an intermediary aggregated state value, and deriving the final aggregated state value from the intermediary aggregated state values. Preferably prior to the steps performed by the coordinating node, each of at least d of the intermediary nodes receives state messages from at least d′ further intermediary nodes belonging to d′ further different sets each further set comprising k′ further intermediary nodes, with d′>1 and k′>1 and k′-1 representing a maximum number of faulty further intermediary nodes being tolerated in each further set, or receives state messages from p out of the n nodes, each state message comprising state value information. Each of the at least d intermediary nodes derives the intermediary aggregated state value from the state value information received, and sends a state message comprising the intermediary aggregated state value to the coordinating node.

The present invention still further provides a system for deriving a final aggregated state value from state value information provided by n nodes in a network, the system comprising the n nodes and d*k intermediary nodes belonging to d different sets each set comprising k intermediary nodes, with d>1 and k>1 and k-1 representing a maximum number of faulty intermediary nodes being tolerated in each set. Further, the system comprises a coordinating node designed for receiving state messages from at least d of the intermediary nodes belonging to d different sets, each state message comprising an intermediary aggregated state value, and for deriving the final aggregated state value from the intermediary aggregated state values. Each of the at least d intermediary nodes is designed for receiving state messages from at least d′ further intermediary nodes belonging to d′ further different sets each further set comprising k′ further intermediary nodes, with d′>1 and k′>1 and k′-1 representing a maximum number of faulty further intermediary nodes being tolerated in each further set, or for receiving state messages from p out of the n nodes, each state message comprising state value information, for deriving the intermediary aggregated state value from the state value information, and for sending a state message comprising the intermediary aggregated state value to the coordinating node.

Accordingly, there is a tree structure introduced for forwarding and/or receiving messages, the tree structure comprising the coordinating node as root and the nodes acting as designation or origin for/from messages as leaves—this is why these nodes are also referred to as final nodes in the following, or as destination and/or origin nodes. From a hierarchical view, the root forms a top-most level of the tree—also referred to as level zero—while at least some of the final nodes are arranged on a bottommost level. In between, there are one or more levels comprising intermediary nodes and eventually final nodes. Typically, the intermediary nodes provide a function of forwarding and/or aggregating information sent between the coordinating node and the final nodes or vice versa. In particular, intermediary nodes on the level below the root of the tree—also referred to as first level—are called intermediary nodes, while intermediary nodes on the second level below the root are also called further intermediary nodes. Whereas the term intermediary node can also be used in general for designating intermediary nodes irrespective of any level they might belong to whenever intermediary nodes are addressed in general.

The number of levels and accordingly the depth of the tree are not limited to two. Any other number of levels provided falls under the scope of the invention. In practice, the number of levels may depend on the overall number of nodes to be communicated to and on existing network infrastructure. However, there is provided a minimum number of one level comprising intermediary nodes below the root level.

A hierarchy of the tree is provided by assigning to intermediary nodes on a given level child nodes on the next lower level and/or parent nodes on the next higher level. Communication is established—and may in some embodiments exclusively allowed—between a node and its child and/or parent node(s) as assigned. It is specific to the invention that to each node arranged on a level lower than the first level—independent from the node being a further intermediary node or a final node—not only one parent node is assigned but at least two parent nodes are assigned which at least two parent nodes are intermediary nodes and which at least two parent nodes form a set, i.e. a parent set. The intermediary nodes belonging to a same set typically show identical behavior and thus can be interpreted as replicated intermediary nodes. This in turn means that in each set comprising k intermediary nodes, failure of k-1 intermediary nodes out of the k intermediary nodes can be tolerated without cutting communication to any single child node assigned to this set. A child node communicating to its parent set on the next higher level typically involves communicating to all parent nodes belonging to this parent set the same information, i.e. the child node transmits messages comprising identical information to all the nodes belonging to the parent set. Vice versa, each of the nodes of a parent set communicates the same information to all child nodes assigned. This insures that even if one or multiple ones of the parent nodes within the set of parent nodes fails, the other parent node(s) of this set still receive(s) messages from the all the child nodes assigned and transmit(s) messages to all the child nodes assigned. It is apparent, that the more intermediary nodes form a set, the more of these intermediary nodes can fail without cutting communication via this set towards the child nodes. At least two child nodes themselves can form a set, also called child set in this context. If such a child set comprises intermediary nodes such intermediary nodes then also act as parent nodes forming a parent set for other child nodes on the next lower level assigned. These other child nodes assigned again qualify by communicating redundantly from each child node to each parent node assigned and vice versa.

However, if any child nodes assigned to a parent set are final nodes, then these final nodes assigned can altogether be also understood as set comprising final nodes characterized in that each of these final nodes receives and/or sends identical messages from/to each of the parent nodes of the parent set assigned.

It is noted, that the nodes on the same level need not to qualify either all of them being intermediary nodes or all of them being final nodes. E.g., a level might comprise a mix of intermediary nodes grouped into one or more different sets, and additionally might comprise final nodes communicating with intermediary nodes assigned on the next higher level, while the intermediary nodes grouped into sets are assigned to final nodes and/or intermediary nodes on the next lower level and to intermediary nodes on the next higher level. However, according to another embodiment, intermediary nodes are exclusively provided in one level, such as the first level exclusively comprises intermediary nodes communicating to the root node and communicating to further intermediary nodes on the next lower level. The next lower level might comprise further intermediary nodes exclusively. In a further embodiment, the next lower level might comprise final nodes exclusively. Preferably, in each level except the root level and the bottommost level sets comprising intermediary nodes are formed.

From what is said above, it can be derived that the numbers of sets d on the first level and the numbers of sets d′ on the second level assigned to one set on the first level do not necessarily match. In the same manner, the number of intermediary nodes k forming a set on the first level and the number of further intermediary nodes k′ forming a further set on the second level do not necessarily match. The number of final nodes p assigned to a parent set is arbitrary, preferably >1.

However, according to an advantageous embodiment the number of sets d on the first level and the number of sets d′ on the second level assigned to one of the sets on the first level do match. Preferably, any number of sets assigned to a parent set matches the number of sets assigned to the coordinating node, and most preferably, the number of final nodes assigned to a parent set matches this number, too. According to another embodiment, the numbers of intermediary nodes k forming a set on the first level and the number of further intermediary nodes k′ forming a further set on the second level do match. Preferably, the number of intermediary nodes k, k′, k″, . . . on any level forming a set do match. According to another advantageous embodiment, the overall number of sets on each level follows d′ with t indicating the level, as well as the number of intermediary nodes k, k′, k″, . . . forming a set is the same for every level. Thus, in this embodiment e.g. further intermediary nodes on a second level of the tree can fulfill the following requirements: d=d′ and d′>1 and k=k′ and k′>1 and k′-1 represents a maximum number of faulty further intermediary nodes being tolerated in each further set.

Generally, in order to reduce the overhead incurred in prior art concepts where one designated node receives individual state value information from every single node and/or transmits a state value to every single node, now a tree-based message routing and processing scheme is introduced. The idea is to impose a tree structure for communication rooted at the coordinating node for use by broadcasts of the group communication system. The tree structure overlays the physical network and aggregates some information to balance the load.

Regarding the flow of messages in both aspects of the present invention, such flow forms a tree-like structure among all sets and the coordinating node, the tree-like structure being rooted at the coordinating node. In both aspects, intermediary nodes are introduced in order to build up such a tree structure with the coordinating node being the root and the nodes being the leaves at the end of each branch of the tree. In terms of levels, the coordinating node builds the topmost level of the tree, while at least some of the final nodes build the bottom layer. In between the topmost level and the bottommost level, intermediary nodes are arranged on intermediary levels. In the first aspect of the invention, these intermediary nodes are used for broadcasting a message received to child nodes assigned which child nodes can be embodied as further intermediary nodes or as destination nodes. In the second aspect of the invention, the intermediary nodes gather information i.e. state value information from child nodes assigned. Such information is aggregated in the intermediary nodes. The aggregated information is forwarded. The child nodes again can be embodied as further intermediary nodes or as origin nodes state value information originates from. In case child nodes are not final nodes of the tree, a sub-child-node layer is expected comprising additional intermediary nodes.

Thus, in an advantageous embodiment, referring to an arbitrary level of the tree structure comprising intermediary nodes the following applies provided both the level above and below comprise intermediary nodes and d and k are equal for every level: Each intermediary node belonging to the same set reports to each one of the k intermediary nodes belonging to a parent set assigned on the next higher level as for communication going up the tree structure; and each intermediary node belonging to the same set reports to all the d*k intermediary nodes of d sets on the next lower level which d sets are assigned as for communication going down the structure. This set-up of intermediary nodes assures that for any communication either going up or down the tree structure a maximum of k-1 intermediary nodes belonging to one set can fail without the communication via this set of intermediary nodes breaking down, as there always remains an intermediary node in this set active which intermediary node can deliver/receive information to/from all the k intermediary nodes assigned on the next higher level and can deliver/receive information from all the k*d intermediary nodes assigned on the next lower level.

The provision of additional intermediary nodes connected the way as described provides a failsafe group messaging system. The intermediary nodes can be understood as logical network nodes mapped to some physical network nodes which physical network nodes originally and/or additionally provide other services. In a very advantageous embodiment, at least one of the n nodes of the group communication system also provides the services of an intermediary or a further intermediary node. Thus, for example, one physical node can perform the function of both a final node and an intermediary node. Also the coordinating node can be understood as logical node embodied on a physical node simultaneously serving as final node. It is preferred, that whenever the services of an intermediary node are implemented at a node serving also as final node, then the final node is arranged within the tree such the a path from the coordinating node to such final node runs via the intermediary node implemented together with the final node on the same network machine i.e. the physical node. In another advantageous embodiment, no two intermediary nodes belonging to the same set are implemented on the same physical node. However, in some embodiments, for each of or some of the intermediary nodes a separate physical node is provided while not simultaneously serving as final node in the network.

It is emphasized that according to very advantageous embodiments the methods according the first and second aspect of the invention can be aggregated to a method in which bidirectional communication is provided for distributing messages comprising state value information from a coordinating node to n nodes as well as providing a final aggregated state value by the coordinating node derived from state value information provided from the n nodes of the network. In particular, the broadcasting of a state value from the coordinating node to all the nodes can be understood as trigger for these nodes to deliver current state value information to the assigned intermediary nodes in order to derive a new final aggregated state value which in turn can again be distributed by the coordinating node to the nodes of the network. Of course, a current state value can be distributed to the nodes, such state value e.g. comprising information about participants of a group or other information related to the state of the system.

In another embodiment the features of the systems according to the first and the second aspect of the present invention are aggregated.

As for the first aspect of the present invention, according to an advantageous embodiment point connection to each intermediary node and a broadcast facility connected to the intermediary the step of sending comprises sending the message through the network using one of a point-to-connection to each intermediary node and a broadcast facility connected to the intermediary nodes, and the step of forwarding comprises sending the request message through the network using one of the point-to-point connection to each one further intermediary node or to each p out of the n nodes and the broadcast facility connected to the further intermediary nodes or to the p out of the n nodes. Preferably, the complete state value is distributed.

As for the second aspect of the present invention, again preferably point-to-point connections between the nodes of different levels assigned to each other can be applied. Preferably, each of the d*k intermediary nodes sends a state message comprising an associated intermediary aggregated value as derived to the coordinating node wherein each intermediary node of the same set delivers the same intermediary aggregated value provided that the k intermediary nodes of this set all perform and provided that no more than k′-1, k″-1, . . . intermediary nodes in assigned child sets fail; thus, the coordinating node receives d*k state messages; by means of these d*k state messages, d different intermediary aggregated state values are delivered as every set of intermediary nodes finally “covers” a different selection of final nodes i.e. every set is responsible for delivering an intermediary aggregated state value derived from the state value information provided by the selection of final nodes which selection includes all the nodes whose branches meet this set in the tree structure; each different intermediary aggregated state value is delivered k times. Thus, the coordinating node receives d different intermediate aggregated state values and receives the same intermediary aggregated state values k′ times under the provision given. However, if 1<k intermediary nodes of a set fail, then the coordinating node receives the state value information provided by this set only k′-1 times. Each intermediary node belonging to the same set receives state messages from each of the d′*k′ further intermediary nodes assigned to this set or from the p nodes assigned to this set. Each further intermediary node belonging to the same further set delivers the same state value information in its state messages provided of course that the k′ further intermediary nodes of this set perform and provided that no more than k″-1, . . . additional intermediary nodes in assigned child sets fail. However, as there are d′ further sets assigned to this set, d′ different state value information is submitted to each intermediary node belonging to the set assigned, as every further set of intermediary nodes finally “covers” a different selection of final nodes i.e. every further set is responsible for delivering state value information derived from the state value information provided by the selection of final nodes which selection includes all the nodes whose branches meet this further set in the tree structure. The same state value information is sent k′ times. Thus, each intermediary node belonging to the same set receives d′ different state value information and receives the same state value information k′ times under the provision given. However, if 1<k′ further intermediary nodes of a further set fail, then each intermediary node of the parent set receives the state value information only k′-1 times. For the case where p final nodes are assigned to a set of intermediary nodes, each of these p final nodes delivers its individual state value information in its state messages to each intermediary node belonging to the same set assigned. Up different state value information is submitted to each intermediary node belonging to the same set assigned. The same state value information is sent k′ times. Thus, each intermediary node belonging to the same set as assigned receives d′ different state value information and receives the same state value information k′ times. In the context of the present paragraph, the term “different” might actually include state value information or intermediate aggregated state values taking the same physical value by chance, however representing intermediate aggregated state values or state information from covering different final nodes as already indicated.

The method and system for deriving a final aggregated state value can further comprise the steps of deriving the final aggregated state value as a vote tally from vote tallies included in the intermediary aggregated state values.

The intermediary nodes preferably derive the associate intermediary aggregated state values from vote counting based on vote values the further intermediary nodes or the nodes provide as state value information. This leads to a reduction of messages and thus causes less communications.

In one embodiment, a vote value can generally take a first vote value, a second vote value, or a third vote value. The intermediary aggregated state value can be derived or determined (i) as the first vote value responsive to receiving d state values identical to the first vote value, and (ii) otherwise, as the second vote value responsive to receiving at least one state value identical to the second vote value, and (iii) otherwise, as the third vote value responsive to receiving at least one state value identical to the third vote value. Examples of such vote values are: commit as first vote value, abort as second vote value, and continue as third vote value, each voting as for accepting a new state at the final nodes which new state prior to the voting was broadcasted by the coordinating node to all the nodes, e.g. by means of the system or the method according to the first aspect of the present invention. Any processing for determining a vote value representing a final node is performed by this final node.

Further each of the nodes can hold a default value and in the event that the default value and a vote value determined by this node are different, each of such nodes sends a state message to the coordinating node comprising the vote value. When the number of faulty nodes is low, e.g. less than 5, then this leads to even less communications.

In general, at the intermediary nodes aggregated state value can be derived by the received state value information by aggregating the state value information received or by evaluating the state value information received according to a scheme such as the one introduced as advantageous embodiment above in which the state value information includes vote values.

In accordance with yet another aspect of the invention there are provided computer program elements comprising computer program code for causing steps of any one of the methods described above performed when said elements are run on processor units of network nodes. Additionally, there are provided a coordinating node and an intermediary node, each of which designed for performing the steps assigned to such nodes in the context of the systems as introduced. Advantages of the apparatus, the computer program elements, the coordinating node and the intermediary node, and their embodiments go along with the advantages and embodiments of the methods and the systems as described above.

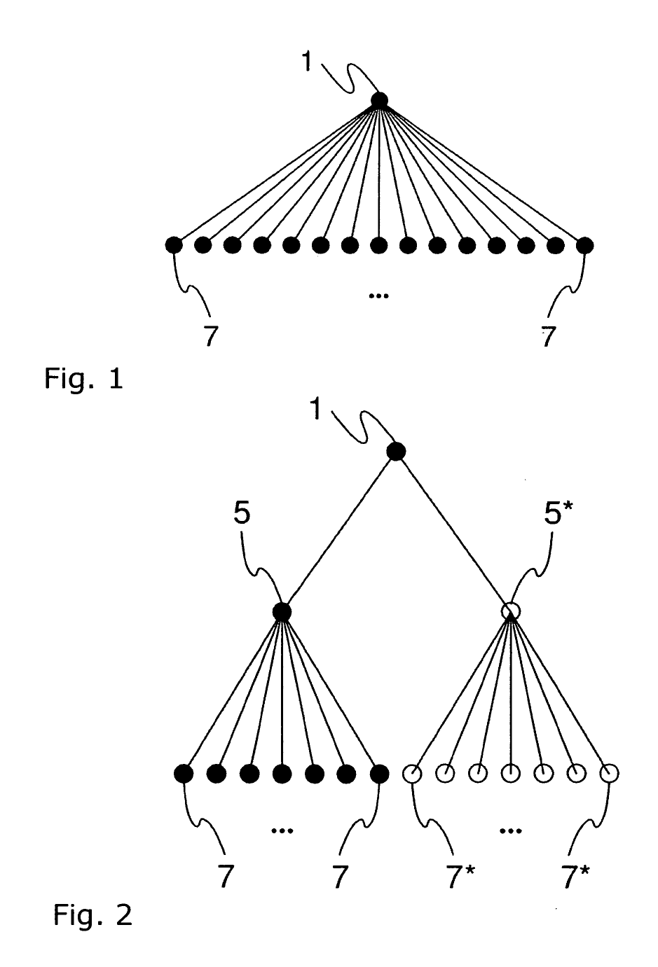

FIG. 1 shows a system of n nodes in a network. In particular, a direct communication between a central node and final nodes is illustrated. The nodes are grouped into a coordinating node 1 and all other nodes, which are also called final nodes 7. The coordinating node 1 sends request messages to and receives state information from all final nodes 7 by means of sending messages over the network through point-to-point connections between the coordinating node 1 and each final node 7.

The drawback is that the coordinating node 1 has to perform a number of computation steps, e.g., for sending or receiving messages, that is directly proportional to n. For large systems comprising a high number n of nodes such computational effort becomes a performance bottleneck for such large systems with many nodes.

When the coordinating node 1 receives information from all the final nodes 7 in order to derive a state value about the system—also referred to as final aggregated state value—, the cost of deriving such final aggregated state value is usually high because the coordinating node 1 has to compute the final aggregated state value from all the information received. Hence, the aggregation step is performed about n times in the coordinating node.

FIG. 2 shows a schematic illustration of a communication between the coordinating node 1 and final nodes 7 by means of a static tree. The network is not fault-tolerant and realized in RSCT topology services (HATS) using hardware broadcast on each subnet for the purpose of sending messages. In this case, only intermediary nodes 5 receive a message from the coordinating node 1. They forward the message to the final nodes 7 using the broadcast facility. Because a broadcast facility is used, the method is not applicable to computing the state value from information received from the final nodes 7.

Although this method does decrease the load of the coordinating node 1 for sending request values, it brings no advantage for computing state values from information received from the final nodes 7. This is because the coordinating node still receives a point-to-point message from all final nodes. The intermediary nodes 5 loop through the information received from the final nodes 7. Moreover, every faulty intermediary node indicated by the reference *, i.e. 5*, causes a communication loss to all final nodes who are descendants of the faulty intermediary node 5*, such as final nodes 7*.

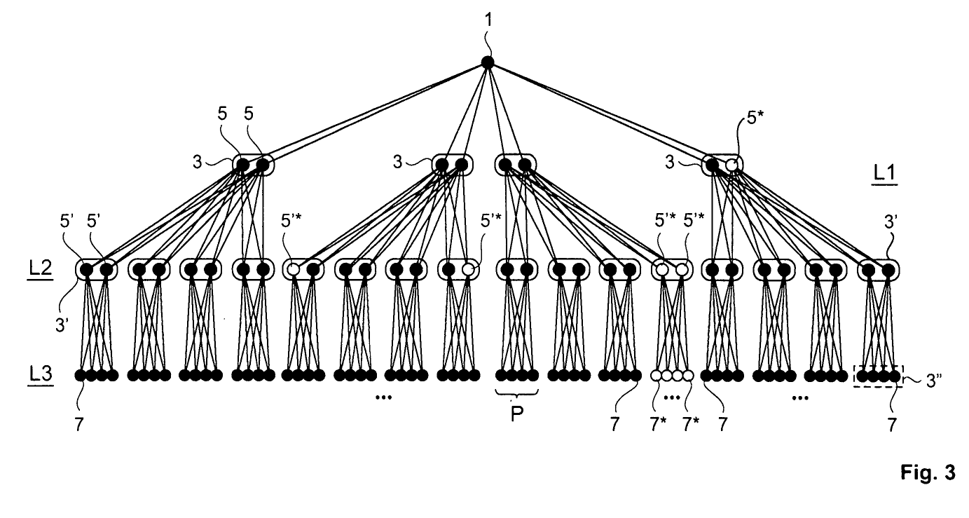

FIG. 3 shows a schematic illustration of a communication between a coordinating node 1 and final nodes 7 in a group communication system of n=d^{t}=4³=64 final nodes 7, with the number of sets d=4 in a first level L1 of the tree and a first level fault-tolerance parameter k=2, with a number of d′=4 further sets 3′ in a second level L2 assigned to each set 3 of the first level L1, with a resulting number of (d=d′=4)²=16 further sets 3′ on this second level L2, with a second level fault-tolerance parameter k=2, and with a depth of the tree t=3. The depth of the tree results in three levels of nodes, intermediary nodes and further intermediary nodes arranged in a tree-like structure. On the first level L1, d*k=8 intermediary nodes 5 are arranged and grouped in d=4 groups each group comprising k=2 intermediary nodes 5. On the next lower level L2, there are arranged d*k′*d′=32 further intermediary nodes 5′ grouped into further sets 3′ each further set 3′ comprising k′=2 further intermediary nodes 5′. Thus, the number of further sets 3′ on the second level L2 is d′²=16.

Each intermediary node 5 on the first level L1 communicates to the coordinating node 1. Each intermediary node 5 on the first level L1 belonging to the same set 3 reports to all the d′*k′ further intermediary nodes 5′ of d further sets 3′ on the next lower level L2 which d′ further sets 3′ are assigned. Vice versa, each further intermediary node 5′ belonging to the same further set 3′ on the second level L2 reports to all the k intermediary nodes belonging to the same set which set is assigned on the next higher level L1 as for communication going up the tree structure; and each further intermediary node 5′ belonging to the same further set 3′ reports to all the p=4 nodes assigned on the next lower L3 which level is exclusively filled with nodes 7.

Due to the setting of the fault-tolerant parameters k=k′=2 the system according to FIG. 3 can tolerate one faulty intermediary node 5* or one faulty further intermediary node 5′* in every set 3 or every set 3* respectively. As a set can also be referred to as virtual node, the system can tolerate k-1 intermediary nodes in every virtual node of the system without loosing communication to any single one final node 7.

As indicated, a single faulty intermediary node 5*—and in general less than k faulty intermediary nodes 5*—in one set 3 does not prevent communication between the coordinating node 1 and the final nodes 7 descendant from the faulty intermediary node 5*, as shown with regard to the very right set 3 on level L1 comprising one faulty node 5*. However, given the fault-tolerance parameter k=k′=2 two faulty nodes in one set or one further set—and in general k faulty intermediary nodes in a single set—may cut off communication to some of the final nodes. k′=2 failures are shown in level L2, where two further intermediary nodes 5′* in the same further set 3′ failed which then results in non accessible final nodes 7*. Again, as long as only one further intermediary node 5* within the same further set 3′ fails, such as shown with regard to two other further sets 3′ on the second level L2, all the downstream nodes 7 can be reached, and thus, the failure of one further intermediary node 5* is tolerated by the system.

Hence, in order to reduce the overhead incurred at one single node, a tree-based message routing and processing is used. A fault-tolerant tree structure is imposed for communication rooted at the coordinating node 1 for use by broadcasts of the group communication system. The tree overlays the physical network and aggregates some information to balance the load. The shown fault-tolerant tree structure allows an efficient message routing.

The group communication is described more mathematically in detail below: Given a description of the group, e.g., a list of all nodes 1, 5, 7, a d-ary not fault-tolerant tree G is constructed such that every node knows its position within the tree. In such a tree G there is no redundancy in intermediary nodes 5—also referred to as internal nodes v—, such tree can e.g. look like the tree according to FIG. 2. For simplicity, it is assumed that there are n nodes with n=d^{t}+1 including the coordinating node and considered a complete d-ary tree G of depth t rooted at the coordinating node 1.

The d-ary k-regular fault-tolerant tree F is obtained from G by adding k-1 copies of every intermediary node in G—which intermediary node is also referred to as internal node; hence, every internal node in G is corresponds to a virtual node or set consisting of k internal nodes u in F. An internal node u in F that is part of a virtual node corresponding to an internal node v in G is connected to all k nodes in the virtual node corresponding to the parent of v and all d*k nodes in the virtual nodes corresponding to the children of v in G. There is only one root node in F, which is linked to d*k nodes at the first level. Thus, there are

$$V = {\sum }_{i = 1}^{t - 1} {d}^{i} = \frac{n - 1}{d - 1} - 1$$

virtual nodes (and internal nodes in G), and F has 1+kV+d^{t} nodes. It is assumed that kV<n.

The nodes of the fault-tolerant tree F are emulated by the physical nodes in the network such that the root of the fault-tolerant tree corresponds to the coordinating node 1 and such that no physical node emulates more than one node in the fault-tolerant tree.

The fault-tolerant tree F gives only a logical structure of the system of n nodes for the purpose of communication. All functions of the internal nodes 5, 5′ are actually executed by some subset of the n nodes in the system which are also referred to as final nodes 7.

The assignment of nodes in the fault-tolerant tree to nodes in the system is done using randomization. Because faults occur independently of the randomization, the choice of this method leads to better tolerance of faults by the system.

To broadcast a message, the coordinating node 1 sends the message to its children and every node sends it on to its own children. The latency is now t hops instead of only one. To return an answer to the coordinating node 1, every node sends the message to its parent, which aggregates the information and derives from it the appropriate value depending on the protocol being carried out, and determines its answer based on that (see below). Only one message is sent from every node towards the root.

For a broadcast from the designated node, there are kV+d^{t} messages being sent over the network in total, but the coordinating node 1 sends only dk messages and no internal node in the fault-tolerant tree sends more than d messages, which means that the load is distributed more evenly when dk<<n. This solution is overall faster if nodes are on physically separate networks. For receiving answers, the same holds: processing cost for receiving at the designated node is reduced to handling at most dk messages. Since the sending operation involves only copying the same message but receiving means examining the contents of the messages, the savings during receiving are likely to be bigger than during sending.

A communication pattern considered in the following embodiment that is from the coordinating node 1 to the final nodes 7 and from the final nodes 7 to the coordinating node 1 can be integrated e.g. in RSCT's topology service, which defines group membership for RSCT, and in RSCT's group services, which handles group communication in RSCT through voting protocols.

In an advantageous embodiment, an n-phase voting protocol is applied in connection with the invention. The voting protocol may change the membership and the shared state of the group of nodes. The n-phase protocol proceeds for multiple rounds that are determined according to the answer messages, called votes sent by the final nodes 7. Thus, state information provided from a final node to its parent nodes comprises a vote value. Possible vote values are commit, abort, or continue, which vote values can be interpreted with respect to a change in a group state communicated by the coordinating node beforehand. Thus, each final node can commit to a communicated change in state, can abort or can request to continue. The vote value of a final node is included as state value information in its state message communicated to its parent nodes.

An intermediary aggregated state value at an intermediary node can be derived or determined from the votes in the state messages received from its child nodes (i) as the first vote value responsive to receiving all state values being identical to the first vote value, and (ii) otherwise, as the second vote value responsive to receiving at least one state value identical to the second vote value, and (iii) otherwise, as the third vote value responsive to receiving at least one state value identical to the third vote value, provided commit is first vote value, abort is second vote value, and continue is third vote value, each voting as for accepting a new state at the final nodes which new state prior to the voting was broadcasted by the coordinating node to all the final nodes.

When having aggregated the state value information of all the final nodes in one or more levels of intermediary nodes and having transferred such intermediary aggregated state value information, the n-phase voting protocol is implemented as follows: If all final nodes vote commit, the protocol terminates and the state change is accepted; otherwise, if at least one node votes abort, the protocol terminates and the state change is rejected; otherwise, i.e., when at least one node votes continue, the voting protocol continues for another round.

Further each of the nodes can hold a default value and in the event that the default value and a vote value determined by this node are different, each of such nodes sends a state message directly to the coordinating node comprising the vote value. The default value can be set at the outset of the protocol but may also be changed during the voting. In an even more specific embodiment, there is introduced a modification concerning an abort or continue vote sent by a correct final node 7 when the default vote is not equal to the vote value. In this case, losing this vote sent from a correct final node 7 and replacing it by the default vote would change the behavior of the system. Hence it is useful that whenever one node sends a vote that is not equal to the default vote (and the vote is also different from commit) the final node 7 sends this vote also directly to the coordinating node 1.

By means of the default value, also a non-responding final node can be handled: The coordinating node 1 receives votes from all final nodes 7, but when a vote is missing after a corresponding timeout has expired, the default value is used for that final node 7. Thus, missing votes after timing out are treated in the same way as by the protocol and the default vote will be propagated towards the root of the tree.

With regard to the voting protocol introduced above, the tree-based message routing approach presented above can even be simplified. For that a “lean” fault-tolerant tree without redundant intermediary nodes, i.e., k=1, can be used. Such tree structure can look like the one illustrated in FIG. 2 comprising final nodes 7 communicating via d sets of intermediary nodes 5, 5′ with the coordinating node 1 each of these sets comprising k=1 intermediary nodes 5. This improvement makes the messaging more efficient because fewer nodes are used for relaying messages. In this context, setting k=1 does not change the outcome of a voting protocol when the internal nodes 5, 5′ in the fault-tolerant tree collect and process the votes received from their children according to the above rule and one modification.

Any disclosed embodiment may be combined with one or several of the other embodiments shown and/or described. This is also possible for one or more features of the embodiments. The present invention can be realized in hardware, software, or a combination of hardware and software. It may be implemented as a method having steps to implement one or more functions of the invention, and/or it may be implemented as an apparatus having components and/or means to implement one or more steps of a method of the invention described above and/or known to those skilled in the art. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Methods of this invention may be implemented by an apparatus which provides the functions carrying out the steps of the methods. Apparatus and/or systems of this invention may be implemented by a method that includes steps to produce the functions of the apparatus and/or systems.

Computer program means or computer program in the present context include any expression, in any language, code or notation, of a set of instructions intended to cause a system having an information processing capability to perform a particular function either directly or after conversion to another language, code or notation, and/or after reproduction in a different material form.

Thus the invention includes an article of manufacture which comprises a computer usable medium having computer readable program code means embodied therein for causing one or more functions described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method for providing a state value to n nodes in a network, comprising:
a coordinating node sending a message comprising at least part of the state value to d*k intermediary nodes forming d sets each set comprising k intermediary nodes, with d>1 and k>1 and k-1 representing a maximum number of faulty intermediary nodes) being tolerated in each set;
each intermediary node forwarding the message received to d′*k′ further intermediary nodes forming d′ further sets each further set comprising k′ further intermediary nodes, with d′>1 and k′>1 and k′-1 representing a maximum number of faulty further intermediary nodes being tolerated in each further set, or forwarding the message received top out of the n nodes.

2. The method according to claim 1, wherein each intermediary node belonging to the same set forwards the message received to the same d′*k′ further intermediary nodes or to the same p nodes.

3. A method for deriving a final aggregated state value from state value information provided by n nodes in a network, comprising:
a coordinating node receiving state messages from at least d intermediary nodes belonging to d different sets each set comprising k intermediary nodes, with d>1 and k>1 and k-1 representing a maximum number of faulty intermediary nodes) being tolerated in each set, each state message comprising an intermediary aggregated state value, and deriving the final aggregated state value from the intermediary aggregated state values;
each of the at least d intermediary nodes receiving state messages from at least d′ of the further intermediary nodes belonging to d′ further different sets each further set comprising k′ further intermediary nodes, wih d′>1 and k′>1 and k′-1 representing a maximum number of faulty further intermediary nodes being tolerated in each further set, or receiving state messages from p out of the n nodes , each state message comprising state value information, deriving the intermediary aggregated state value from the state value information, and sending a state message comprising the intermediary aggregated state value to the coordinating node.

4. The method according to claim 3, wherein:
each of the d*k intermediary nodes sends a state message comprising an intermediary aggregated state value to the coordinating node; and
each intermediary node belonging to the same set receives state messages from each of the d′*k′ further intermediary nodes assigned or from the p nodes assigned.

5. The method according to claim 3, comprising the coordinating node deriving the final aggregated state value as a vote tally from vote tallies included in the intermediary aggregated state values.

6. The method according to claim 3, comprising the intermediary nodes deriving the intermediary aggregated state values from vote values the further intermediary nodes or the nodes provide as state value information.

7. The method according to claim 6,
wherein a vote value can take a first vote value, a second vote value, and a third vote value; and
wherein the intermediary aggregated state value is determined as:
the first vote value if d state value information received are identical to the first vote value;
otherwise, the second vote value if at least one state value information received is identical to the second vote value; and
otherwise, the third vote value if at least one state value information received is identical to the third vote value.

8. The method according to claim 7, comprising each of the nodes holding a default value for sending a state message to the coordinating node in the event that the default value and a vote value determined for each said each of the nodes are different, the state message comprising the vote value determined.

9. Computer program elements comprising program code for causing the steps of the method of claims 1 to be performed when said elements are run on processor units of network nodes.

10. A system for providing a state value to n nodes in a network, comprising:
the n nodes;
d*k intermediary nodes forming d sets each set comprising k intermediary nodes, with d>1 and k>1 and k-1 representing a maximum number of faulty intermediary nodes being tolerated in each set;
a coordinating node designed for sending a message comprising at least part of the state value to the d*k intermediary nodes;
each of the d*k intermediary nodes designed for forwarding the message received to d′*k′ further intermediary nodes forming d′ further sets each further set comprising k′ further intermediary nodes, with d′>1 and k′>1 and k′-1 representing a maximum number of faulty further intermediary nodes being tolerated in each further set, or to d out of the n nodes.

11. A system for deriving at least one final aggregated state value from state value information provided by n nodes in a network, comprising:
the n nodes;
d*k intermediary nodes belonging to d different sets each set comprising k intermediary nodes, with d>1 and k>1 and k-1 representing a maximum number of faulty intermediary nodes being tolerated in each set;
a coordinating node designed for receiving state messages from at least d of the intermediary nodes belonging to d different sets, each state message comprising an intermediary aggregated state value, and for deriving the final aggregated state value from the intermediary aggregated state values;
each of the at least d intermediary nodes designed for receiving state messages from at least d′ further intermediary nodes belonging to d′ further different sets each further set comprising k′ further intermediary nodes, with d′>1 and k′>1 and k′-1 representing a maximum number of faulty further intermediary nodes being tolerated in each further set, or for receiving state messages from d out of the n nodes, each state message comprising state value information, for deriving the intermediary aggregated state value from the state value information, and for sending a state message comprising the intermediary aggregated state value to the coordinating node.

12. A coordinating node, designed for performing the steps as assigned to a coordinating node in claim 10.

13. An intermediary node, designed for performing the steps as assigned to an intermediary node in claim 10.

14. The method according to claim 4, comprising the coordinating node deriving the final aggregated state value as a vote tally from vote tallies included in the intermediary aggregated state values.

15. The method according to claim 4, comprising the intermediary nodes deriving the intermediary aggregated state values from vote values the further intermediary nodes or the nodes provide as state value information.

16. A coordinating node, designed for performing the steps as assigned to a coordinating node in claim 11.

17. An intermediary node, designed for performing the steps as assigned to an intermediary node in claim 11.

18. An article of manufacture comprising a computer usable medium having computer readable program code means embodied therein for causing provision of a state value to n nodes in a network, the computer readable program code means in said article of manufacture comprising computer readable program code means for causing a computer to effect the steps of claim 1.

19. A program storage device readable by machine, tangibly embodying a program of instructions executable by the machine to perform method steps for deriving a final aggregated state value from state value information provided by n nodes in a network, said method steps comprising the steps of claim 3.

20. A computer program product comprising a computer usable medium having computer readable program code means embodied therein for causing functions of a system for deriving at least one final aggregated state value from state value information provided by n nodes in a network, the computer readable program code means in said computer program product comprising computer readable program code means for causing a computer to effect the functions of claim 11.
